(19) United States
(12) Patent Application Publication
(10) Pub. No.: US 2007/0098868 A1
(43) Pub. Date: May 3, 2007

(54) Frozen desserts and methods for manufacture thereof

(76) Inventors: Aaron Chip Venables, Yardley, PA (US); Jamie Lynn Frangella, Mt. Laurel, NJ (US); Bruce D. Poulterer, Media, PA (US); Thomas Ruszkay, Hockessin, DE (US)

Correspondence Address: Patent Administrator;FMC Corporation, 1735 Market Street, Philadelphia, PA, 19103, US

(21) Appl. No.: 11/584,444

(22) Filed: Oct. 20, 2006

Related U.S. Application Data
(60) Provisional application No. 60/782,057, filed on Mar. 14, 2006.
(60) Provisional application No. 60/774,692, filed on Feb. 17, 2006.
(60) Provisional application No. 60/751,501, filed on Dec. 19, 2005.
(60) Provisional application No. 60/734,647, filed on Nov. 8, 2005.
(60) Provisional application No. 60/729,140, filed on Oct. 21, 2005.

(51) Int. Cl. A23G 9/00

(52) U.S. Cl. 426/565

(57) ABSTRACT

Lower process viscosity methods for the production of frozen products are disclosed. The methods can be used to prepare frozen desserts, such as ice cream, that have outstanding sensory properties and reduced fat content. This is especially advantageous for individuals who for health or other reasons desire to reduce their caloric intake without sacrificing the eating qualities of their frozen desserts. The present invention is also directed to frozen desserts, as well as materials used therein.

This application claims the benefit of U.S. Provisional Application No. 60/782,057, filed Mar. 14, 2006; U.S. Provisional Application No. 60/774,692, filed Feb. 17, 2006; U.S. Provisional Application No. 60/751,501, filed Dec. 19, 2005; U.S. Provisional Application No. 60/734,647, filed Nov. 8, 2005, and U.S. Provisional Application No. 60/729,140, filed Oct. 21, 2005.

### FIELD OF THE INVENTION

The invention relates to frozen desserts and materials used therein. Furthermore, this invention relates to low in process viscosity methods for the production of frozen desserts and materials used therein.

### BACKGROUND OF THE INVENTION

In the food industry, the term “frozen desserts” is a market category that encompasses a wide variety of products that are served at temperatures below the freezing point of water. Frozen desserts include dairy-based food desserts such as ice cream, ice milk, sherbet, gelato, frozen yogurt, soft serve ice cream; nondairy-based desserts such as mellorine, sorbet, and water ices; and specialty items such as frozen novelties, e.g., bars, cones, and sandwiches. Frozen desserts also include reduced fat (also called low-fat or light) and no fat (also called fat-free) versions of many of these frozen desserts. In recent years, reduced fat frozen desserts and no fat frozen desserts have become a significant, growing segment of the frozen desserts market.

Frozen desserts typically are multiphase compositions: solid, liquid and air, with the liquid sometimes including oil and water phases. This characteristic of frozen desserts, which is the basis for their food appeal to consumers, presents the manufacturer with difficulties in maintaining the desired product qualities until the frozen dessert is ultimately consumed. Negative sensory characteristics in frozen desserts usually result from perceived body or textural defects. A particularly common textural defect in frozen desserts results from the formation of large ice crystals, a problem often aggravated by fluctuations in storage temperature.

The developer of reduced calorie frozen desserts faces the formidable challenge of providing products that have outstanding organoleptic properties while at the same time reducing their caloric content. Sugar and fat contribute to the mouthfeel of these products and provides bulk and/or structure. Therefore, removal of these materials produces desserts that have unsatisfactory texture and/or consistency. In addition, these products should maintain a relatively high degree of softness when serving, and should not require a large tempering time before serving to attain the desired soft state. However, when sugar and/or fat are reduced, the freezing point of the frozen dessert is altered, making the product unacceptably hard and icy.

A stabilizer is added to produce a frozen dessert that will maintain acceptable organoleptic properties. During manufacturing, stabilizers maintain homogeneity and control ice-crystal growth during freezing and aeration. During storage, they resist structural changes during “heat shock,” the temperature-cycling during storage and distribution that causes ice-crystal growth and other types of deterioration due to structural changes. During serving and consumption, stabilizers contribute to uniform meltdown, mouthfeel, and texture.

Microcrystalline cellulose coprocessed with carboxymethyl cellulose has been used to help control a wide range of defects related to shelf-life deterioration and to provide processing advantages. Over stabilization, in which a high level of hydrocolloid is perceived as a negative gummy texture, is a problem when hydrocolloids other than microcrystalline cellulose are used, but it is typically not a problem when microcrystalline cellulose is used as the stabilizer. Consequently, coprocessed microcrystalline cellulose/carboxymethyl cellulose can be used at higher levels than other hydrocolloid stabilizers.

However, the use level of conventional stabilizers such as microcrystalline cellulose in conventional processes is generally limited by the in process viscosity. High in process viscosity reduces overall plant production and, in addition, can cause the seals in plate heat exchangers to rupture and/or cause the mix to overheat due to reduced flow through the heat exchanger. Thus, a need exists for a method of forming frozen desserts in which the resulting dessert has acceptable organoleptic properties due to a high level of microcrystalline cellulose, but which does not suffer from the disadvantages caused by high in process viscosity.

### SUMMARY OF THE INVENTION

An embodiment of the present invention is a lower in process viscosity method for the preparation of frozen desserts as well as the frozen desserts made by such method. The method achieves enhanced qualities for the frozen desserts while at the same time lowering their levels of fats and/or solids. In one aspect of the invention, the method comprises the steps of:

a) preparing a mix comprising ingredients suitable for the preparation of the frozen dessert, in which the mix comprises less than the desired amount of colloidal microcrystalline cellulose;

b) pasteurizing and homogenizing the mix;

c) adding to the mix an added amount of colloidal microcrystalline cellulose, the added amount being the amount necessary to achieve the desired amount of colloidal microcrystalline cellulose;

d) aerating and freezing the mix; and

e) hardening the mix;

in which the steps are carried out in the order step a), step b), step c), step d); and step e); or carried out in the order step a) step b), step d), step c), and step e), in which step c) is carried out with shear.

In another aspect of the invention, the method comprises the steps of:

a) preparing a first fraction, the first fraction comprising at least some ingredients suitable for the preparation of the frozen dessert, in which the first fraction contains less than the desired amount of colloidal microcrystalline cellulose;

b) preparing a second fraction, the second fraction comprising colloidal microcrystalline cellulose;

c) pasteurizing and homogenizing the first fraction;

d) pasteurizing but not homogenizing the second fraction;

e) mixing the first fraction and the second fraction in proportions appropriate to give a mix comprising the ingredients, in the desired amounts, suitable for the preparation of the frozen dessert;

f) aerating and freezing the mix; and

g) hardening the mix.

In yet another aspect of the invention, the method comprises the steps of:

a) preparing a mix comprising ingredients suitable for the frozen dessert, in which the mix comprises the desired amount of colloidal microcrystalline cellulose and in which the colloidal microcrystalline cellulose is fluid bed dried microcrystalline cellulose;

b) pasteurizing and homogenizing the mix, in which the homogenization is carried out at a pressure of about 4.9×1010⁵ kg/m² to about 1.05×10⁶ kg/m², and in which the in process viscosity in step b) does not exceed 400 cp;

c) aerating and freezing the mix; and

d) hardening the mix.

An additional embodiment of the present invention is a method of producing a frozen dessert comprising the steps of preparing a dessert composition and freezing the dessert composition, wherein colloidal microcrystalline cellulose is added to the dessert composition during at least one of before, during or after said freezing step with the proviso that at least a portion of the colloidal microcrystalline cellulose is activated during or after the freezing step.

A further embodiment of the present invention is a frozen dessert composition comprising colloidal microcrystalline cellulose wherein the colloidal microcrystalline cellulose consists of: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein the colloidal microcrystalline cellulose has a viscosity greater than 150 cp when measured at 2.6% solids using RVT Brookfield viscometer, spindle #1 at 20 rpm.

An additional embodiment of the present invention is a colloidal microcrystalline cellulose consisting of: (i) carboxymethyl cellulose having (a) a viscosity of about 25 to about 50 cp for a 2% solution/as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein the colloidal microcrystalline cellulose has a viscosity greater than 150 cp when measured at 2.6% solids using RVT Brookfield viscometer, spindle #1 at 20 rpm.

Another embodiment of the present invention is a colloidal microcrystalline cellulose consisting of coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein said colloidal microcrystalline cellulose has a viscosity greater than 150 cp when measured at 2.6% solids using RVT Brookfield viscometer, spindle #1 at 20 rpm, and the carboxymethyl cellulose and microcrystalline cellulose are spray dried after being coprocessed.

### DETAILED DESCRIPTION OF THE INVENTION

In the specification, examples, and claims, unless otherwise indicated, percents are percents by weight. For frozen dessert formulations, the percent of an ingredient given is the percent by weight of the indicated ingredient based on the total weight of the mix. Except where indicated by context, terms such as stabilizer, emulsifier, flavoring, and similar terms also refer to mixtures of such materials. All temperatures are in ° C. (Celsius), unless otherwise indicated. “Frozen desserts” include dairy-based food desserts such as ice cream, ice milk, sherbet, gelato, frozen yogurt, milk shakes, soft serve ice cream; nondairy-based desserts such as mellorine, sorbet, and water ices; and specialty items such as frozen novelties, e.g., bars, cones, and sandwiches. “Colloidal microcrystalline cellulose” or “colloidal MCC” refers to microcrystalline cellulose that has been coprocessed with carboxymethyl cellulose. Microcrystalline cellulose coprocessed with other hydrocolloid gums, such as, for example, alginate, guar gum, or xanthan gum, may also be useful in the practice of the invention.

In one embodiment, the present invention is directed to a method of producing a frozen dessert comprising the steps of preparing a dessert composition and freezing the dessert composition, wherein colloidal microcrystalline cellulose is added to the dessert composition during at least one of before, during or after the freezing step with the proviso that at least a portion of the colloidal microcrystalline cellulose is activated during or after the freezing step. More particularly, at least 1 wt %, at least 5 wt %, at least 10 wt %, at least 20 wt %, at least 30 wt %, at least 35 wt %, at least 50 wt %, at least 60 wt %, at least 70 wt %, at least 80 wt %, at least 90 wt %, at least 95 wt %, at least 98 wt %, at least 99 wt %, at least 100 wt % of the colloidal microcrystalline cellulose is activated during or after the freezing step. All other processes of the present invention disclosed herein may be used in practicing this inventive embodiment. The present invention is also directed to frozen desserts made in accordance with this process.

Activation of colloidal microcrystalline cellulose, as used herein, is defined as the point at which sufficient mechanical force has been applied to a powder particulate of colloidal microcrystalline cellulose that results in hydration and physical separation of the individual submicron size microcrystals within an aqueous medium. Activation allows for the formation of a 3 dimensional network of insoluble colloidal particles resulting in increased viscosity and weak gel structures that impart desirable mouthfeel and physical stability to food products such as frozen desserts. The degree or % activation of colloidal microcrystalline cellulose is easily determined using light microscopic analysis.

In conventional processes, dessert compositions having dairy components are generally prepared, homogenized/pasteurized and then frozen. Activation of colloidal microcrystalline cellulose in such conventional processes occurs prior to the freezing step because the colloidal microcrystalline cellulose is present in the initial dessert composition and then homogenized resulting in fully activated colloidal microcrystalline cellulose in the dessert composition prior to the freezing step. In contrast, in each of the embodiments of the present invention, it is possible that at least 35% of the colloidal microcrystalline cellulose is activated during or after the freezing step. If desired, one can also adjust the salt content to retard the activation of the MCC prior to the freezing step. For example, such salts that can be adjusted include food grade salts that can be used in dairy or desirably in non-dairy based compositions (such as soy protein based formulations, water ices, and sorbets), and salts present in MSNF, desirably used in dairy based compositions.

As described in more detail below, processes used for the manufacture of frozen desserts typically include the steps of ingredient blending, pasteurization, homogenization, cooling, aging, aeration, freezing, hardening, and packaging. Following pasteurization, the hot mix is homogenized by forcing the hot liquid through a very small orifice at high pressure, typically about 1.41×10⁶ kg/m² (about 2000 psi) to 1.76×10⁶ kg/m² (about 2500 psi). The presence of a high level of colloidal microcrystalline cellulose in the mix during the homogenization step causes the viscosity of the mix to be too high for efficient processing. However, it has been discovered that the problems of high viscosity during processing can be avoided by appropriate modification of the manufacturing method so that the frozen dessert is produced by a lower viscosity method. During this method the viscosity of the mix during pasteurization and homogenization suitably does not exceed 400 cp, typically does not exceed 300 cp, and may not exceed 250 cp, as measured by a Brookfield viscometer operating at 50 rpm with spindle #2 for 60 seconds. Frozen desserts that comprise up to 1.6 wt % of colloidal MCC can be readily produced by this method.

In one embodiment of the low viscosity method, some, or all, of the desired amount of the colloidal microcrystalline cellulose stabilizer is added to the mix after the pasteurization and homogenization steps. The microcrystalline cellulose stabilizer may be added either: 1) before the aeration and freezing steps, or 2) after the aeration and freezing steps but before and/or during the hardening step. If the colloidal MCC is added after the aeration and freezing steps but before and/or during the hardening step, it is necessary to generate enough sheer stress to completely activate the colloidal MCC during the succeeding steps.

When some or all of the desired amount of the colloidal microcrystalline cellulose stabilizer is added to the mix after the pasteurization and homogenization steps but before the aeration and freezing steps, typically the hot mix from the pasteurization and homogenization steps is allowed to cool and age, and then added to a blender. The added amount of colloidal MCC is added and dispersed in the mix before the aeration, freezing, and, if desired, hardening steps. The added amount of colloidal MCC may be added during any part of the process between the pasteurization and homogenization steps and the aeration and freezing steps, such as, for example, in the flavor tank or during pumping of the mix to the flavor tank.

When some or all of the desired amount of the colloidal microcrystalline cellulose stabilizer is added to the mix after both the pasteurization and homogenization steps, and the aeration and freezing steps, but before the hardening step, colloidal microcrystalline cellulose stabilizer is added into the semi-frozen mixture upon exiting the scrape surface freezing mechanism of a continuous freezer. The semi-frozen mixture is further worked/mixed/churned to generate enough sheer stress to completely activate the colloidal MCC.

When some or all of the desired amount of the colloidal microcrystalline cellulose stabilizer is added to the mix during and/or after the hardening step, it is necessary to supply sufficient sheer stress to completely activate the colloidal MCC. Partial freezing of the freezable water (up to about 80% of the freezable water in the mix is frozen by the end of the hardening step) causes a large increase in the viscosity of the mix. The colloidal MCC may be advantageously added before and/or during the hardening step when about 50-60% of the freezable water in the mix has been frozen. Equipment suitable for providing adequate sheer stress to completely activate the colloidal MCC during hardening is disclosed, for example, in WO 2005/070225 A1 and Windhab, U.S. Pat. Pub. 2005/0037110.

Before the pasteurization, the mix may comprise a stabilizer. The stabilizer may be colloidal MCC; a stabilizer system such as GELSTAR® XP 3542, which contains a mixture colloidal MCC and other stabilizers; or a stabilizer or stabilizer system that does not comprise colloidal MCC. Other stabilizers that may be present include hydrocolloids such as, for example, agar, pectin, gelatin, gum acacia, guar gum, xanthan gum, locust bean gum, gum tragacanth, tara gum, starch, methylcellulose, carrageenan and its salts, carboxymethyl cellulose, sodium alginate, propylene glycol alginate, and microcrystalline cellulose coprocessed with hydrocolloids other than carboxymethyl cellulose, which may be used by themselves or in mixtures with each other, with or without, colloidal microcrystalline cellulose.

The total amount of colloidal MCC added after the pasteurization and homogenization steps will depend on the amount of stabilizer, if any, already present in the mix, and the total amount of stabilizer desired in the finished frozen dessert to achieve the desired eating quality. The amount of stabilizer present in the mix during homogenization should not exceed that amount which will produce an acceptable in process viscosity for the mix, typically 400 cp or less during the pasteurization and homogenization steps.

The total amount of stabilizer desired in the finished frozen dessert will depend on the nature of the frozen dessert, the fat content of the frozen dessert, and the final texture desired. The frozen dessert, for example, ice cream, may typically comprise, for example, about 15 wt % of butterfat or less than about 15 wt % of butterfat, about 10 wt % of butterfat or less than about 10 wt % of butterfat, about 8 wt % of butterfat or less than about 8 wt % of butterfat, about 5 wt % of butterfat or less than about 5 wt % butterfat, about 2 wt % of butterfat or less than about 2 wt % butterfat, about 0.5 wt % of butterfat or less than about 0.5 wt % butterfat, or about 0 wt % butterfat. As the amount of fat in the frozen dessert is decreased, the amount stabilizer is increased to maintain the texture and body of the frozen dessert. For example, for an ice cream mix containing 5% butterfat and about 0.1 wt % to about 0.8 wt % of a colloidal microcrystalline cellulose stabilizer system in the mix before pasteurization, post pasteurization addition of an added amount of about 0.2 wt % to about 1.0 wt %, typically about 0.4 wt % to about 0.9 wt %, of colloidal MCC will produce an ice cream containing 5% butterfat that has the texture and body of a 10% butterfat ice cream. When the stabilizer present in the mix before homogenization is MCC or an MCC containing stabilizer system, the desired amount of stabilizer in the finished ice cream is suitably about 0.3 wt % to 1.6 wt %, typically greater than 0.8 wt % to about 1.6 wt %, and more typically about 1.0 wt % to 1.4 w %.

When a frozen dessert that contained 0 wt % butterfat and about 1.2 wt % to 1.4 wt % of colloidal MCC was prepared, good body and texture were apparent, but milk solids flavor was detected, which is typical of nonfat mixes. Although flavors may be added to replace the milk solids flavor with a nonfat flavor, flavors do not provide the typical eating characteristics, such as texture, body, and mouthfeel, provided by butterfat.

An ice cream that contains 10 wt % butterfat and 1.1 wt % of colloidal MCC is extremely smooth and rich and has the possibilities of making an economy formulation with the quality of a premium or super premium frozen dessert. For mixes that contain about 0.3 wt % to about 0.6 wt % of a stabilizer before pasteurization, an added amount of up to about 1 wt % colloidal MCC has been added by this method. Higher added amounts of colloidal MCC are feasible, but, when total amount of colloidal MCC in the ice cream (the amount on the mix before pasteurization plus the amount added after pasteurization) exceeded about 1.6 wt %, an ice cream with undesirable eating qualities was produced. The amounts of added colloidal MCC and the total amounts of stabilizer to be used for frozen desserts other than ice cream may be readily determined by those skilled in the art.

In another embodiment of the lower viscosity method, mix fractionation is used. This method involves the preparation of two separate fractions and combining them to obtain the desired mix. The first fraction comprises some or all of the added colloidal MCC and may comprise some or all of the ingredients that do not need to be homogenized, for example some or all of the sugar, the sweetener, and/or the MSNF. The second fraction contains all the butterfat and may contain a stabilizer, such as MCC or an MCC containing stabilizer system, as well as the remainder of the ingredients suitable for the preparation of the frozen dessert.

The second fraction is pasteurized and homogenized, but the first fraction is pasteurized but not homogenized. The amount of stabilizer present in the second fraction during homogenization should not exceed that amount which will produce an acceptable in process viscosity for the second fraction, typically 400 cp or less during the pasteurization and homogenization steps. Then the fractions are mixed in appropriate proportion to give a mix that comprises the desired composition for the finished frozen dessert. The mix is frozen and, if desired, hardened. By this method, compositions similar to those prepared by the post pasteurization addition of colloidal MCC embodiment, described above, may be prepared.

In still another embodiment of the lower viscosity method of the present invention, all the colloidal MCC is added before homogenization, but homogenization is carried out at reduced pressure to properly homogenize the butterfat without activating (i.e., dispersing) the colloidal MCC. In the conventional process, homogenization is typically carried out at about 1.76×10⁶ kg/m² (about 2500 psi). Typical conditions which do not activate the colloidal MCC but yet are effective to homogenize the butterfat are above a homogenization pressure of about 4.9×1010⁵ kg/m² (about 700 psi), about 5.6×10⁵ kg/m² (about 800 psi), or about 7.0×10⁵ kg/m² (about 1000 psi), and below about a homogenization pressure of about 1.05×10⁶ kg/m² (about 1500 psi), about 9.8×10⁵ kg/m² (about 1400 psi), or about 9.1×10⁵ kg/m² (about 1300 psi). In this embodiment, the colloidal MCC is activated in the freezer barrel when the temperature falls below the freezing point of water, preferably to about −5.0° C. (about 23° F.) or less, more preferably, to about −6.1° C. (about 21° F.) or less. Though not being bound by any theory or explanation, it is believed that the presence of ice crystals activates the colloidal MCC in the freezer barrel. Fluid bed dried colloidal MCC is preferred for use in this embodiment.

The present invention is also directed to frozen desserts made in accordance with the inventive processes herein.

Frozen desserts may be evaluated by sensory analysis, in which structure, or body, and the texture of the frozen dessert are evaluated by a panel of consumers. In sensory analysis, frozen desserts of the present invention, produced by the method of the invention, that contained about 5 wt % butterfat were evaluated and found to be equivalent to similar frozen desserts produced by conventional methods that contained 10% butterfat.

Frozen desserts may also be evaluated for freeze thaw stability. Temperature cycling (heat shock) during storage causes unwanted and undesired negative textural changes (i.e., stickiness, iciness), especially in low fat and/or reduced solids frozen desserts. For ice cream or low fat frozen desserts containing a 0.6 wt % colloidal MCC stabilizer system, addition of 0.6 wt % colloidal MCC to the frozen desserts will maintain their textural characteristics without any other measurable changes, yielding good eating quality over multiple heat shock cycles.

Frozen desserts may further be evaluated by melt down time. In this test, an 8 oz. cup of frozen dessert, such as ice cream, is placed on a 10 mesh wire screen. For a typical ice cream, this is equivalent to about 100 g of ice cream. As the dessert melts, the weight of material that passes through the screen is recorded against time. The amount passing through the screen is considered to be the amount melted. The procedure is typically carried at a standard temperature such as 19.4° C. (67° F.). Ice cream containing 5 wt % butterfat produced by the method of the invention is typically less than about 40% melted, more typically less than about 30% melted, after 120 minutes at 19.4° C. (67° F.). For example, in a melt down test, an ice cream outside the scope of the invention containing 0.6 wt % of a colloidal microcrystalline cellulose stabilizer system and 0.6 wt % of additional spray dried colloidal microcrystalline, added after pasteurization and homogenization but before freezing and hardening, was only about 28% melted after 120 minutes at 19.4° C. (67° F.).

Frozen desserts include dairy-based food desserts such as ice cream, ice milk, sherbet, gelato, frozen yogurt, soft serve ice cream, and milk shakes; nondairy-based desserts such as mellorine, sorbet, and water ices; and specialty items such as frozen novelties, e.g., bars, cones, and sandwiches. The formulation and manufacture of frozen desserts is well known to those skilled in the art and is available from many sources, including the internet. The composition and labeling of many of these products is controlled by governmental regulation, which may vary from country to country. For example, one regulation requires that ice cream contains at least 10% milk fat and at least 20% milk solids. Low fat ice cream contains a maximum of 3 grams of total fat per serving (½ cup), and nonfat ice cream contains less than 0.5 grams of total fat per serving.

Ice cream is a frozen dessert made from a mixture of dairy and non-dairy products to give the desired level of fat and “milk solids non-fat” (MSNF), which, together with sugar, sweetener, flavoring, coloring, emulsifier, and stabilizer, is made smooth by whipping or stirring during the freezing process. Ice cream is a complex mixture containing ice crystals, fat globules and air cells. The ice crystals and fat globules are very small and well divided in order to produce a smooth texture without any “fatty taste”.

Ice cream includes a dairy source, such as whole milk, skim milk, condensed milk, evaporated milk, anhydrous milk fat, cream, butter, butterfat, whey, and/or milk solids non-fat (“MSNF”). The dairy source contributes dairy fat and/or non-fat milk solids such as lactose and milk proteins, e.g., whey proteins and caseins. Vegetable fat, for example, cocoa butter, palm, palm kernal, sal, soybean, cottonseed, coconut, rapeseed, canola, sunflower oils, and mixtures thereof, may also be used. MSNF is made up of approximately 38% milk protein, 54% lactose, and 8% minerals and vitamins.

The sugar used may be sucrose, glucose, fructose, lactose, dextrose, invert sugar either crystalline or liquid syrup form, or mixtures thereof. The sweetener may be a corn sweetener in either a crystalline form of refined corn sugar (dextrose and fructose), a dried corn syrup (corn syrup solids), a liquid corn syrup, a maltodextrin, glucose, or a mixture thereof. Sugar substitutes, sometimes called high potency sweeteners, such as sucralose, saccharin, sodium cyclamate, aspartame, and acesulfame may be used in addition to or in place of some or all of the sugar.

Air is incorporated to provide desirable properties. The amount of air incorporated is referred to as “overrun”. Overrun is expressed as a percentage, and refers to the relative volumes of air and mix in the package. For example, ice cream in which the volume of air is exactly equal to the volume of mix is said to have 100% overrun. When overrun is properly incorporated, it is in the form of finely divided and evenly distributed air cells that help provide structure and creaminess. The air cells are dispersed in the liquid portion, which contains the other ingredients of the ice cream. The overrun for ice cream products aerated using a conventional freezer is in the range of about 20% to about 250%, preferably of about 40% to about 175%, more preferably of about 80% to about 150%. The overrun for molded ice cream products aerated using a whipper is in the range of about 40% to about 200%, preferably of about 80% to about 150%. The overrun for aerated water ice is in the range of about 5% to about 100%, preferably of about 20% to about 60%.

Other ingredients of ice cream include, for example, flavorings, colorings, emulsifiers, and water. These ingredients are well known to those skilled in the art. Emulsifiers include, for example, propylene glycol monostearate; sorbitan tristearate; lactylated monoglycerides and diglycerides; acetylated monoglycerides and diglycerides; unsaturated monoglycerides and diglycerides, including monoglycerides and diglycerides of oleic acid, linoleic acid, linolenic acid, or other commonly available higher unsaturated fatty acids; and mixtures thereof. Emulsifiers typically comprise about 0.01% to about 3% of the mix. In addition to all the other ingredients in the formulation, water makes up the balance of the mix.

Gelato is similar to ice cream, but contains more milk than cream and also contains sweeteners, egg yolks and flavoring. Mellorine is a frozen dessert in which vegetable fat has replaced cream. Italian-style gelato is denser than ice cream, because it contains less overrun. Sherbets have a milkfat content of between 1% and 2%, MSNF up to about 5 wt %, and slightly higher sweetener content than ice cream. Sherbet is flavored either with fruit or other characterizing ingredients. Frozen yogurt consists of a mixture of dairy ingredients such as milk and nonfat milk that have been cultured with a yogurt culture, as well as ingredients for sweetening and flavoring. Following pasteurization typical for ice cream processing, the composition is inoculated with a yogurt culture. When the desired acidity had been attained, it is cooled. Frozen custard or French ice cream must also contain a minimum of 10% milkfat, as well as at least 1.4% egg yolk solids. Sorbet and water ices are similar to sherbets, but contain no dairy ingredients.

Microcrystalline cellulose is purified, partially depolymerized cellulose, which may be obtained from various sources of cellulose, such as wood, wood pulps such as bleached sulfate and sulfate pulps, cotton, flax, hemp, bast or leaf fibers, regenerated forms of cellulose, soy hulls, corn hulls, or nut hulls, by a combination of a chemical degradation and mechanical attrition. Chemical degradation may be accomplished by any of several well-known methods. Generally, the source of cellulose, preferably a source of α-cellulose, in the form of a pulp from fibrous plants, is treated with a mineral acid, preferably hydrochloric acid. The acid selectively attacks the less ordered regions of the cellulose polymer chain, thereby exposing and freeing the crystallite sites, forming the crystallite aggregates which constitute microcrystalline cellulose. These are then separated from the reaction mixture and washed to remove degraded by-products. The resulting wet mass, generally containing 40-60 wt % moisture, is referred to in the art by several names, including hydrolyzed cellulose, microcrystalline cellulose, microcrystalline cellulose wetcake, or simply wetcake.

The average particle size of the microcrystalline cellulose may be reduced of from about 0.1 to about 10 microns by attrition. Attrition of the cellulose particles to form colloidal particles may be carried out using any suitable apparatus such as a SILVERSON® mixer. The resulting microcrystals are then co-processed with a hydrophilic barrier dispersant, to keep the microcrystals from reaggregating during the drying process. Coprocessed microcrystalline cellulose/carboxymethyl cellulose, commonly referred to as colloidal microcrystalline cellulose, as described above, is disclosed in Durand, U.S. Pat. No. 3,539,365.

Properly dispersed, colloidal microcrystalline cellulose (MCC) sets up into a three-dimensional network of colloidal particles, which imparts stability to finished products. In water, with shear, colloidal microcrystalline cellulose forms a three-dimensional matrix that form an extremely stable, thixotropic gel. Because microcrystalline cellulose functions at any temperature, it provides freeze/thaw and heat stability to finished products. The three-dimensional network is extremely effective in maintaining the three phase system of water/fat/air.

Various grades of colloidal microcrystalline cellulose approved for food use and mixtures thereof may be used in the practice of the invention. The carboxymethyl cellulose coprocessed with the microcrystalline cellulose can be about 0.6% to 1.2% substituted and may be high viscosity, medium viscosity, low viscosity carboxymethyl cellulose. Typical viscosity ranges for carboxymethyl cellulose, measured in water at 25° C., are high viscosity, about 1,000 to about 6,000 cp for a 1% solution (LVF Brookfield viscometer; spindle #3 and #4, speed: 30 rpm); medium viscosity, about 100 to about 3,100 cp for a 2% solution (LVF Brookfield viscometer; spindle #2 and #3; speed: 30 rpm); and low viscosity, about 25 to about 50 cp for a 2% solution (LVF Brookfield viscometer; spindle #1 and #2; speed: 30 rpm) or about 50 to about 200 cp for a 4% solution (LVF Brookfield viscometer; spindle #1 and #2; speed: 60 rpm). The colloidal microcrystalline cellulose may be dried by any method normally used, such as spray drying, fluid bed drying, roller drying, or drum drying.

In general, the colloidal microcrystalline cellulose preferred in the processes of the present invention are those utilizing low viscosity carboxymethyl cellulose and, in the processes other than when a fluid dried microcrystalline cellulose is required, the preferred microcrystalline cellulose is spray dried and processed for higher viscosity. An example of a preferred colloidal microcrystalline cellulose is one containing only: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein the colloidal microcrystalline cellulose has a viscosity greater than 150 cp when measured at 2.6% solids using RVT Brookfield viscometer, spindle #1 at 20 rpm.

Another example of a preferred colloidal microcrystalline cellulose is one containing only a coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein the colloidal microcrystalline cellulose has a viscosity greater than 150 cp when measured at 2.6% solids using RVT Brookfield viscometer, spindle #1 at 20 rpm, and the carboxymethyl cellulose and microcrystalline cellulose are spray dried after being coprocessed.

Colloidal microcrystalline cellulose, i.e., microcrystalline cellulose coprocessed with carboxymethyl cellulose, that may be used in the present invention is available from FMC Corporation under the trade names AVICEL®, AVICEL-PLUS®, and NOVAGEL®, for example, AVICEL® RC 581, AVICEL® CG 200, AVICEL® RC 591, AVICEL® RC-791, AVICEL®501, AVICEL® IC 2121, AVICEL® IC 2153, AVICEL® IC 5250, AVICEL® MV 3257, AVICEL® RC 501, AVICEL® GP-2119, AVICEL-PLUS® VC 3318, AVICEL-PLUS® XP 3563, AVICEL-PLUS® SD 3410, AVICEL-PLUS® XP 3572, AVICEL-PLUS® IC 2310, AVICEL-PLUS® IC 2219, AVICEL-PLUS® XP 3269, AVICEL-PLUS® IC 2315, AVICEL-PLUS® SD 3410, NOVAGEL® GP 2180, NOVAGEL® GP 2289, NOVAGEL® GP 3282, AVICEL® XP 3540 and GELSTAR XP 3623. The colloidal microcrystalline cellulose to be used in the present invention generally does not contain ingredients that require heat for solubilization. An example of such an excluded material is Gelstar XP or IC 3542. Other colloidal microcrystalline celluloses approved for food use, and mixtures thereof, may also be useful.

The present invention is also directed to a frozen dessert composition comprising colloidal microcrystalline cellulose wherein the colloidal microcrystalline cellulose consists of: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein the colloidal microcrystalline cellulose has a viscosity greater than 150 cp when measured at 2.6% solids using RVT Brookfield viscometer, spindle #1 at 20 rpm. The frozen dessert composition may further comprise 3-8% by weight of butterfat.

The present invention is also directed to a colloidal microcrystalline cellulose consisting of coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein the colloidal microcrystalline cellulose has a viscosity greater than 150 cp when measured at 2.6% solids using RVT Brookfield viscometer, spindle #1 at 20 rpm, and the carboxymethyl cellulose and microcrystalline cellulose are spray dried after being coprocessed. The carboxymethyl cellulose may be present in an amount of 5-20 wt %, more particularly, 15 wt %, by weight of the colloidal microcrystalline cellulose. The present invention is also directed to frozen desserts containing the colloidal microcrystalline cellulose described in this paragraph, as well as to frozen desserts containing colloidal microcrystalline cellulose wherein the colloidal microcrystalline cellulose described in this paragraph is 100 wt % of all colloidal microcrystalline cellulose present in the frozen dessert.

The frozen dessert manufacturing process will be briefly described for ice cream. However, with appropriate modifications well known to those skilled in the art of frozen dessert manufacture, other types of frozen desserts can be prepared. The preparation of frozen desserts is described, for example, in Ice Cream, 6^{th} Ed., by R. T Marshall, H. D. Goff, and R. W. Hartel, Springer, N.Y., 2003.

Generally, the methods used for the manufacture of frozen desserts include the steps of: ingredient blending to prepare a mix, pasteurization, homogenization, cooling, aging, aeration or whipping, freezing, and packaging. The methods can be either batch or continuous. Ingredients may be either liquid or dry, or a combination of both. In the conventional process, the amount of each individual ingredient required is weighed out or metered out, and the ingredients are blended together into a liquid mixture called “mix”.

Although any approved pasteurization process, such as the UHT (ultra high temperature) process and the LTLT (low temperature long time) process, can be used in the practice of the invention, pasteurization is typically carried out in HTST (high temperature short time) units, in which the homogenizer is integrated into the pasteurization system. The mix is then heated to a specific temperature and held at that temperature for a time to accomplish pasteurization. Although the pasteurization time and temperature is specified by governmental regulations and may vary from country to country, typical pasteurization conditions for the HTST process are heating the mix to at least 79.4° C. (175° F.) for at least 25 sec. Pasteurization kills pathogenic microorganisms that may have been in the liquid mix. Following pasteurization, the hot mix is homogenized to bring about an intimate association of all the components and achieve a permanent uniformity by forcing the hot liquid through a very small orifice at high pressure, typically over about 1.41×10⁶ kg/m² (about 2000 psi).

After the pasteurized and homogenized mix is cooled, it is then aged for anywhere from 20 minutes to overnight, preferably at least four hours. To achieve specific flavor properties, flavor can be added to the mix before it is frozen.

Following cooling and aging, the next step is known as “freezing”, during which the conversion of water to ice begins. Typically, during the aeration and freezing steps, the mix is partially frozen in scraped surface heat exchangers know as ice cream freezers. Air is dispersed around the rotating scraper blades. At a conventional draw temperature of about 21° F. (−5° C.), about 40% of the freezable water is frozen. Freezing occurs progressively as the mix passes under pressure from one end of a very cold cylinder to the other. As ice forms on the surface of the cylinder it is removed by sharp blades moving over the surface at a high speed. During the passage through the freezing cylinder, aeration takes place as air is whipped into the mixture. The semi-frozen product emerges from the freezing/aeration equipment with two components that were not present in the liquid mix: air and ice. Further flavoring materials such as fruits, nuts, candies, syrups, etc., can be injected into the semi-frozen product before it is packaged.

The next step, which is typically carried out after packaging, is known as “hardening”. The aerated mix is then fed, preferably directly, e.g., by pumping through a filler, to a container or package, and then hardened. In this step, the packaged product is subjected to extremely low temperatures, as low as about −40° C. (about −40° F.), in equipment designed to cool it rapidly. An additional 30-40% of the freezable water is frozen during hardening. Rapid cooling is important for the development of the extremely small ice crystals, which are necessary to give ice cream a smooth, creamy texture. Some frozen desserts, such as soft-serve, are not hardened after freezing.

Alternatively, shear may be applied to the mix during the hardening step. For example, in one process, sheer stress is be applied when about 50-60% of the freezable water in the mix is frozen, and the shear stress is about 500 to 75,000 Pa, typically 5,000 to 15,000 Pa, such as described in Windhab, U.S. Pat. Pub. 2005/0037110, and in WO 2005/070225 A1, the disclosures of which are both incorporated herein by reference. If the colloidal MCC is added after aeration and freezing and before or during hardening, sufficient shear must be supplied to activate the colloidal MCC. When shear is applied during the hardening step, the packaging typically is not done until after hardening.

After hardening, aerated frozen products may be stored at a freezing temperature, usually at a temperature of about −25° C. (about −13° F.) to about −35° C. (about −31° C.). The remainder of the freezable water typically freezes during this process. Specialty items such as bars, cones, sandwiches, and other frozen novelties may also be prepared. For example, coatings that contain inclusions such as nut pieces or fruit pieces may be added to individual items. The product may be placed between cookies, or other edible substrates to form ice cream sandwiches.

### INDUSTRIAL APPLICABILITY

The process of the invention can be used to prepare frozen desserts, such as ice cream, ice milk, sherbet, gelato, frozen yogurt, soft serve ice cream, mellorine, sorbet, and water ices that have outstanding sensory properties and/or reduced fat content. This is especially advantageous for individuals who for health or other reasons desire to reduce their caloric intake without sacrificing the eating qualities of their frozen desserts.

The advantageous properties of this invention can be observed by reference to the following examples, which illustrate but do not limit the invention.

### EXAMPLES

### Glossary

AQUALON® 7HF Carboxymethyl cellulose, high viscosity (Hercules, Wilmington, Del., USA)
Carrageenan SEAKEM® IC 518 (FMC Corporation, Philadelphia, Pa., USA)
Colloidal MCC Microcrystalline cellulose coprocessed with carboxymethyl cellulose
GELSTAR® XP 3542 Commercially available microcrystalline cellulose stabilizer system (FMC, Philadelphia, Pa., USA). This product may also be referred to as GELSTAR® IC 3542
Guar Gum PAKCOL FG/6070 (Pakistan Gum Industries, Karachi, Pakistan)
ICE 2 Emulsifier, Mono- and diglycerides/PS 80 blend (Loders & Crooklaan, Channahon, Ill., USA)
Locust Bean Gum Unclarified LBG 200M (PL Thomas, Morristown, N.J., USA)
Maltodextrin M-100 Hydrolyzed starch, 10 DE (Grain Processing Corporation, Muscatine, Iowa, USA)
Maltisweet IC solids Maltitol Syrup (SPI Polyol, New Castle, Del., USA)
MSNF Milk solids non-fat
Sucralose SPLENDA® sucralose (Tate & Lyle, Decatur, Ill., USA)
Polydextrose STA-LITE® III polydextrose (Tate & Lyle, Decatur, Ill., USA)

### Example 1

This example shows the preparation and evaluation of 5% butterfat ice cream samples and comparison with a full fat (10% butterfat) ice cream sample.

### Sample Preparation

All the ice cream samples were prepared using typical HTST (high temperature/short time) processing conditions. Prior to pasteurization, milk and cream were added to a 10-gallon Breddo Likwifier blender (American Ingredients Co., Kansas City, Mo. USA) under mild agitation. The composition of each of the samples is given in Table 1. Percent is percent by weight of the indicated ingredient based on the total weight of the mix.

TABLE 1

| | Example # | | | | | | | | |
|---|---|---|---|---|---|---|---|---|---|
| | 1-1 | 1-2 | 1-3 | 1-4 | 1-5 | 1-6 | 1-7 | 1-8 | 1-9 |
| Component | % | % | % | % | % | % | % | % | % |
| Butterfat | 5 | 5 | 5 | 10 | 5 | 5 | 5 | 5 | 5 |
| MSNF | 12 | 12 | 12 | 12 | 12 | 12 | 12 | 12 | 12 |
| Sucrose | 10 | 10 | 12 | 12 | 10 | 10 | 10 | 10 | 10 |
| Corn Syrup Solids | 10 | 10 | 6 | 6 | 10 | 10 | 10 | 10 | 10 |
| (36 DE) | | | | | | | | | |
| GELSTAR ® IC 3542 | 0.6 | 0.7 | 0.75 | — | — | — | — | — | — |
| Colloidal MCC^{a} | — | — | — | — | — | — | — | — | 0.8 |
| Colloidal MCC^{b} | — | — | — | — | 0.3 | 0.3 | 0.3 | 0.3 | 0.3 |
| Maltodextrin M-100 | 2 | — | — | 0.02 | 2.02 | 2.05 | 2.02 | 2.02 | 1.22 |
| Locust Bean Gum | — | — | — | — | — | — | 0.08 | 0.04 | — |
| Guar Gum | — | — | — | 0.04 | — | — | 0.08 | 0.04 | — |
| AQUALON ® 7HF | — | — | — | 0.07 | 0.15 | 0.15 | — | 0.08 | 0.15 |
| ICE 2 | — | — | — | 0.115 | 0.12 | 0.09 | 0.12 | 0.12 | 0.12 |
| Carrageenan | — | — | — | 0.002 | 0.006 | 0.006 | 0.01 | 0.006 | 0.006 |
| Total Solids | 39.6 | 37.7 | 35.75 | 40.25 | 39.6 | 39.6 | 39.6 | 39.6 | 39.6 |

^{a}Colloidal MCC added after pasteurization.
^{b}Colloidal MCC added prior to pasteurization.

Each mix was agitated for about 10 minutes prior to pasteurization to mix the ingredients. Pasteurization was carried out on a HTST (high temperature short time) system set to homogenize the mix at about 1.76×10⁶ kg/m² (about 2500 psi), followed by holding at a temperature of about 82.2° C. (about 180° F.) for 25 seconds. Following pasteurization, each mix was immediately cooled to about 10° C. (about 50° F.) and allowed to age overnight. Samples 1-1 to 1-8 were flavored with a Category #2 vanilla (vanilla-vanillin extract, considered to be natural and artificial vanilla), followed by freezing on a WCB Model 100 continuous freezer (WCB Ice Cream, Northvale, N.J., USA). Sample 1-9 was flavored and subsequently placed in the blender with light agitation. The colloidal MCC was added slowly to each mix and allowed to wet out for about 3 minutes. The resulting mix for each sample was drained and fed to the continuous freezer.

Each product was frozen at about −5.8° C. (about 21.5° F.) with an overrun of 100%. Once conditions for each mix were established, several pint containers of each variable were collected and placed in an about −34.4° C. (about −30° F.) blast freezer for hardening. Prior to evaluation, 1 pint of each sample was placed in a tempering cabinet at about −17.7° C. (about 0° F.) for several hours.

### Evaluation

Each sample was evaluated by sensory analysis. Sensory analysis was completed by manipulating a spoonful size of ice cream in the mouth and subjectively determining the structure or body of the mass. Body can be classified as weak, gummy, crumbly, short, fluffy, or soggy. Texture is the other main parameter to consider while completing a sensory analysis. Descriptors of texture include coarseness, iciness, sandy, or greasy. Body and texture descriptors are ranked as either being heavy, moderate, or light. Prior to the sensory evaluations, the samples were tempered to about −15° C. (about 5° F.). Various panels agreed that the sample from Example 1-9, the product of the invention, out performed the other samples in creamy texture and fullness of body. Further evaluations of a sample from Example 1-4 (10% butterfat control) scored against a sample from Example 1-9 found a richer/creamier texture in Example 1-9.

Heat shock abuse was applied to each sample by placing a pint container of each sample in a temperature controlled cycling cabinet programmed to maintain about −6.7° C. (about 20° F.) for 12 hours followed by cooling to about −17.8° C. (about 0° F.) for 12 hours. This cycling pattern was repeated for 7 days. Sensory scoring of these samples showed that the sample from Example 1-9 was rated as providing the least change in ice crystal size. Other samples were recorded to have high or moderate degree of iciness.

### Example 2

This example illustrates the optimal use level of microcrystalline cellulose to add post pasteurization needed in this formulation/process to generate an eating quality that mimics that of or exceeds that of a 10% control ice cream.

Following the procedure of Example 1, the samples shown in Table 2 were prepared. Table 2 shows the composition of two 10% control products, one with a conventional soluble gum based stabilizer (Example 2-1) and a second with a colloidal MCC stabilizer (Example 2-2). Examples 2-1 and 2-2 are comparative examples. The levels of colloidal MCC incorporated into the mix post pasteurization in accordance with the present invention were 0%, 0.4%, 0.6%, 0.8%, and 1.0% (Examples 2-3 to 2-7). In addition, a control composition was prepared where a higher level of colloidal MCC was added prior to pasteurization (Example 2-8) resulting in a comparative example whereby all the colloidal MCC is activated prior to the freezing step.

TABLE 2

| | Example # | | | | | | | |
|---|---|---|---|---|---|---|---|---|
| | 2-1 | 2-2 | 2-3 | 2-4 | 2-5 | 2-6 | 2-7 | 2-8 |
| Component | % | % | % | % | % | % | % | % |
| Butterfat | 10 | 10 | 5 | 5 | 5 | 5 | 5 | 5 |
| MSNF | 10 | 10 | 10 | 10 | 10 | 10 | 10 | 10 |
| Whey | 2 | 2 | 2 | 2 | 2 | 2 | 2 | 2 |
| Sucrose | 12 | 12 | 12 | 12 | 12 | 12 | 12 | 12 |
| Corn Syrup Solids | 6 | 6 | 8 | 8 | 8 | 8 | 8 | 8 |
| (36 DE) | | | | | | | | |
| Colloidal MCC^{a} | — | — | — | 0.4 | 0.6 | 0.8 | 1 | — |
| Colloidal MCC^{b} | — | — | — | — | — | — | — | 0.8 |
| Maltodextrin M-100 | 0.02 | — | 1.2 | 1.2 | 1.2 | 1.2 | 1.2 | 1.2 |
| GELSTAR ® XP 3542 | — | 0.45 | 0.6 | 0.6 | 0.6 | 0.6 | 0.6 | 0.6 |
| Guar Gum | 0.04 | — | — | — | — | — | — | — |
| AQUALON ® 7HF | 0.07 | — | — | — | — | — | — | — |
| ICE 2 | 0.12 | — | — | — | — | — | — | — |
| Carrageenan | 0.002 | — | — | — | — | — | — | — |
| Total Solids | 40.3 | 40.5 | 38.8 | 39.2 | 39.6 | 39.4 | 39.8 | 39.6 |

^{a}Colloidal MCC added after pasteurization.
^{b}Colloidal MCC added prior to pasteurization.

Processing was carried out as described in Example 1. The composition formed in Example 2-8, which contained 1% of colloidal MCC added before pasteurization, could not be processed efficiently because excessive line pressure in the cooling section stopped flow through the HTST unit. Mix weights of the remaining 7 samples and the amount of colloidal microcrystalline cellulose added are given in Table 3.

TABLE 3

| | | % Colloidal MCC | Colloidal MCC |
|---|---|---|---|
| Sample # | Mix Weight (kg) | (post addition) | added (g) |
| 2-1 | 21.2 | — | — |
| 2-2 | 21.7 | — | — |
| 2-3 | 19.4 | — | — |
| 2-4 | 18.6 | 0.4 | 79 |
| 2-5 | 25.6 | 0.6 | 156 |
| 2-6 | 24.6 | 0.8 | 217 |
| 2-7 | 21.4 | 1.0 | 227 |

Each mix that required post addition (charging) of colloidal MCC was placed in the Breddo blender and brought to a slight vortex. The additional colloidal MCC was added to the vortex and allowed to wet for 3 minutes. After charging the mixes, they were returned to their original holding containers until the freezing operation. No appreciable increase in mix viscosity was observed in any of the charged mixes.

It was subjectively determined as the ice cream was being drawn off the freezer that the sample from Example 2-4, charged with an additional 0.4% of colloidal MCC, was significantly warmer and creamier than the sample from Example 2-3, in which the mix was not charged.

Evaluation of finished hardened samples was completed in two sets. Set #1 compared samples 2-2, 2-4, and 2-5. Set #2 compared samples 2-5, 2-1, and 2-7

TABLE 4a
(Set #1)

| Example # | Body (1-3) | Texture (1-3) |
|---|---|---|
| 2-2 | 2 | 1 |
| 2-4 | 2.5 | 1 |
| 2-5 | 3 | 1 |

TABLE 4b
(Set #2)

| Example # | Body (1-3) | Texture (1-3) |
|---|---|---|
| 2-1 | 1.5 | 1 |
| 2-6 | 3 | 1 |
| 2-7 | 3 | 1 |

Sensory analysis of uncycled samples show that both 10% control samples ranked less in body and texture than either of the samples charged with colloidal MCC. Added amounts as low as 0.4% of colloidal MCC, produced a product that had the eating qualities of a full fat product. As the level of colloidal MCC increases from 0.4% through 0.8%, the texture is further enhanced. Post addition of 1.0% colloidal MCC produced a product that was generally considered to be undesirable in eating quality.

In a 28 person panel evaluating the sample from Example 2-5 against the sample from Example 2-2, 93% of the panel members agreed that the sample from Example 2-5 (5% fat light ice cream) was richer/creamier than the sample from Example 2-2 (10% control product).

### Example 3

Following the procedure of Example 1, the samples shown in Table 5 were prepared. A conventional stabilization system was created to stabilize the formulation used in Example 1. Locust bean gum and guar gum were formulated into a 5% butterfat product and compared to the same 5% butterfat formulation using GELSTAR® IC 3542 as the stabilizer. Each of these mixes were charged with 0.6% colloidal MCC after pasteurization.

TABLE 5

| | Example # | | |
|---|---|---|---|
| | 3-1 | 3-2 | 3-3 |
| Components | % | % | % |
| Butterfat | 5 | 5 | 5 |
| MSNF | 10 | 10 | 10 |
| Whey powder | 2 | 2 | 2 |
| Sucrose | 12 | 12 | 12 |
| Corn Syrup Solids (36 DE) | 8 | 8 | 8 |
| Colloidal MCC^{a} | 0.6 | 0.6 | — |
| Maltodextrin M-100 | 1.2 | 1.26 | 1.26 |
| GELSTAR ® IC 3542 | 0.6 | — | — |
| Locust Bean Gum | — | 0.07 | 0.07 |
| Guar Gum | — | 0.04 | 0.04 |
| ICE 2 | — | 0.12 | 0.12 |
| Carrageenan | — | 0.01 | 0.01 |
| Total Solids | 39.4 | 39.1 | 38.5 |

^{a}Colloidal MCC added after pasteurization

The resulting products were evaluated via sensory testing both before and after heat shock abuse. The sample from Example 3-1, which contained GELSTAR® IC 3542 as the base stabilization system and to which colloidal MCC had been added after pasteurization, was evaluated as being significantly smoother, warmer, and richer eating than either the sample from Example 3-2 or the sample from Example 3-3. Following heat shock abuse, the samples from Example 3-2 and 3-3 were measurably more coarse and icy than the sample from Example 3-1.

### Example 4

Three different procedures were used to incorporate the stabilizer. In Examples 4-1 and 4-2, the samples were processed by adding the entire stabilization system (e.g., colloidal MCC) to the initial mix followed by pasteurization and homogenization. However, the homogenization pressure was reduced to about 7.03×10⁵ kg/m² (about 1000 psi) in the first stage instead of the standard (about 1.76×10⁶ kg/m² (about 2500 psi)) to homogenize the butterfat without activating the colloidal MCC. Sample 4-1 is a comparative sample because all the colloidal MCC was fully activated prior to freezing, while the fluid bed colloidal MCC in Sample 4-2 was activated in accordance with the invention (after the freezing step) because it was a fluid bed dried product.

In Example 4-3, the sample was processed using mix fractionation. This method involves preparing two separate mixes and combining the finished mix fractions to obtain the desired finished composition. In fraction A, all the butterfat in the finished composition was added as well as the MSNF, sucrose, corn syrup, and the GELSTAR® IC 3542 stabilizer. This fraction was pasteurized and homogenized at about 1.76×10⁶ kg/m² (about 2500 psi) in a 2-stage homogenization, to achieve the proper particle size reduction of the butterfat. Mix B was prepared to deliver the balance of the solids in the formulation as well as the colloidal MCC without the need for homogenization. The colloidal MCC in Example 4-3 was the same colloidal MCC used in Example 1. To prepare the final composition, 14.5 kg of fraction A was added to 4.83 kg of fraction B to yield 19.33 kg of the final composition.

The sample from Example 4-4 was prepared in the same manner as the sample from Example 1-9, in which the colloidal MCC was added after pasteurization, using the colloidal MCC used in Examples 4-1 and 4-3. Example 4-1 is a comparative example, and examples 4-2 to 4-4 are inventive examples.

The compositions used are shown in Table 6.

TABLE 6

| | Example # | | | | | |
|---|---|---|---|---|---|---|
| | | | | | 4-3 | |
| | | | Fraction | Fraction | 75/25 Mix | |
| | 4-1 | 4-2 | A | B | A/Mix B | 4-4 |
| Components | % | % | % | % | % | % |
| Butterfat | 5 | 5 | 6.67 | — | 5.0 | 5.0 |
| MSNF | 10 | 10 | 13 | 9 | 12.0 | 12.0 |
| Whey powder | 2 | 2 | 0 | 0 | 0.0 | 0.0 |
| Sucrose | 12 | 12 | 11.3 | 14 | 12.0 | 12.0 |
| Corn Syrup | 8 | 8 | 8 | 8 | 8.0 | 8.0 |
| (36 DE) | | | | | | |
| Colloidal MCC | 0.6 | — | — | 2.4 | 0.6 | 0.6 |
| Spray Dried* | | | | | | |
| Colloidal MCC | — | 0.6 | — | — | — | — |
| Fluid Bed | | | | | | |
| Dried# | | | | | | |
| GELSTAR ® | 0.6 | 0.6 | 0.8 | — | 0.6 | 0.6 |
| IC 3542 | | | | | | |
| Maltodextrin | 1.2 | 1.2 | — | 4.8 | 1.2 | 1.2 |
| M-100 | | | | | | |
| Total Solids | 39.4 | 39.4 | 39.77 | 38.2 | 39.4 | 39.4 |

*AVICEL XP 3540
#AVICEL GP-2119

Initial Brookfield viscosities were recorded on each mix as it exited the HTST pasteurization system with an RVT Brookfield viscometer operating at 50 rpm with spindle #2 for 60 seconds. Zahn cup readings were also recorded. Zahn cups are standard size stainless steel cups with a standard hole size located on the bottom. Viscosity is measured as a function of time it takes for the flow of the mix to stop from the bottom of the cup.

TABLE 7

| | Brookfield Viscosity | |
|---|---|---|
| Sample # | (cps) | # 2 Zahn Cup (sec) |
| 4-1 | 616 | >90 |
| 4-2 | 228 | 67 |
| 4-3 Fraction A | 184 | 50 |
| 4-3 Fraction B | 232 | 60 |
| 4-4 | 160 | 42 |

Brookfield viscosity and Zahn cup readings record a significantly higher viscosity in sample 4-1. Samples 4-2 to 4-4 are much lower in viscosity, demonstrating that either: 1) a fluid bed dried colloidal MCC coprocessed with CMC can be used in a process with reduced homogenization pressure; or 2) a fractionated process with a spray dried colloidal MCC ingredient can be used without the issue of high mix viscosity. The much higher viscosity reading of the sample from Example 4-1 (616 cps) demonstrates the difficulties a manufacturer would encounter with processing this ingredient in traditional mix preparation procedures.

Each sample was frozen at −5.8° C. (about 21.5° F.) with an overrun of 100% on a continuous freezer. Once the process conditions for each mix were established, several pint containers were collected and placed in an about −34.4° C. (about −30° F.) blast freezer for hardening.

Sensory analysis of the hardened ice creams indicated that the samples from Examples 4-1, 4-3, and 4-4 each have the desired mouthfeel characteristics required to make a 5% ice cream have the same rich eating qualities of a full fat ice cream. The sample from Example 4-2, although slightly inferior in eating quality to the other samples, still retained good eating qualities and would be a feasible option to manufacturers incapable or unwilling to process mix by the alternative inventive procedures described Examples 4-3 and 4-4. However, as mentioned above, sample 4-1 is a comparative sample because of the significant processing problems associated with the much higher viscosity.

### Example 5

This Example shows post addition of colloidal microcrystalline cellulose in several formulations types. All components were added into the mix prior to pasteurization in samples 5-1 to 5-5, except for the colloidal microcrystalline cellulose. Non fat ice cream (Example 5-1), low fat (2% butterfat) (Example 5-2), full fat (10% butterfat) (Example 5-4) ice cream, 5% butterfat with no added sugar ice cream (Example 5-5), and 4% vegetable fat ice cream (Example 5-3) were prepared. The formulations are shown in Table 8. All of samples 5-1 to 5-5 are examples of the present invention.

TABLE 8

| | Sample | | | | |
|---|---|---|---|---|---|
| | 5-1 | 5-2 | 5-3 | 5-4 | 5-5 |
| Component | % | % | % | % | % |
| Vegetable Fat (Coconut Oil) | — | — | 4 | — | — |
| Butterfat | — | 2 | — | 10 | 5 |
| MSNF | 12 | 12 | 11.5 | 10 | 10 |
| Whey powder | — | — | — | — | 2 |
| Sucrose | 12 | 11 | 12 | 12 | — |
| Corn syrup solids (36 DE) | 6 | 7 | 6 | 6 | — |
| Maltisweet IC solids | — | — | — | — | 9 |
| Polydextrose | 3.6 | 1.7 | — | — | 4.5 |
| Colloidal MCC^{a} | 0.8 | 0.7 | 0.6 | 0.5 | 0.6 |
| GELSTAR ® IC 3542 | 0.6 | 0.6 | 0.6 | 0.6 | 0.65 |
| Maltodextrin M-100 | — | — | — | — | 4.5 |
| Sucralose | — | — | — | — | 0.011 |
| Acesulfame K | — | — | — | — | 0.011 |
| Total Solids | 35 | 35 | 34.7 | 39.1 | 36.272 |

^{a}Colloidal MCC added after pasteurization: AVICEL XP 3540

All samples with the exception of Sample 5-3 were processed as described in Example 1. Due to the high melting point of the coconut oil (about 36° C., 97° F.), for Sample 5-3, the water and vegetable fat were preheated to about 71° C. (about 160° F.) prior to the addition of the remaining solids.

The finished ice creams were evaluated to determine acceptability and quality. All samples received high comments for the category of ice cream each sample represents. At 0% fat (Example 5-1), good body and texture were apparent. However an abundance of milk solids flavor was detected, which is typical of nonfat mixes. The addition of cream flavor is recommended for this sample.

The sample from Example 5-2 (2% butterfat) was extremely rich and creamy for such a low fat content and presents excellent potential as a low fat product that retains the quality of a good light product (5% fat). Similarly, the sample from Example 5-4 (10% fat) is extremely smooth and rich and has the possibilities of making an economy ice cream formulation with the quality of a super premium formulation. In their product categories, the samples from Example 5-3 and 5-5 were also described as rich and creamy.

### Example 6

A sample having the composition of Example 2-3 was prepared and processed as in Example 2. Following processing (pasteurization), 0.6% colloidal MCC was added and the samples evaluated to determine the temperature at which the colloidal MCC becomes active in the freezer barrel. At startup of the freezing process, the mix initially exits the freezer barrel at refrigeration temperatures of about 4.4° C. (about 40° F.), and the exit temperature continuously drops to a desired fill temperature of about −5.5 to about −6.1° C. (about 22° F. to about 21° F.).

Samples were removed at various temperatures and evaluated with polarized light microscopy to evaluate the degree of activation (i.e., disassociation) of the colloidal MCC. Table 9 shows the relationship of draw temperature to activation.

TABLE 9

| Draw Temperature | Activation (%) |
|---|---|
| 4.4° C. (40° F.) | 0 |
| −2.7° C. (27° F.) | 50 |
| −5.0° C. (23° F.) | 90 |
| −6.1° C. (21° F.) | 100 |

Table 9 shows that the consistency (stiffness)/temperature of the ice cream in the freezer barrel correlates to the degree of activation of colloidal MCC. At 4.4° C. (40° F.), with no ice present, the agitation of the freezer barrel is insufficient to activate the colloidal MCC. At −2.7° C. (27° F.), the concentrated mix is sufficient to render about 50% of the product (colloidal MCC) active. Further drops in temperatures to −5.0° C. (23° F.) and −6.1° C. (21° F.) produce higher concentrations of ice crystals and thus higher degree of particulate attrition sufficient to effectively activate the colloidal MCC.

This example suggests that applications such as molded bars, where a loose product consistency is necessary to fill the molds, would not benefit from the full activation of colloidal MCC to provide maximum structure/body in the finished product.

### Example 7

This example demonstrates the dry addition of colloidal MCC to a semi-frozen mix where the colloidal MCC is activated at this stage. Using a preferred combination of temperature and shear intensity, the colloidal MCC can be uniformly mixed and activated in accordance with the present invention to produce a finished ice cream with the same or even superior eating qualities as the inventive ice cream prepared in Example 2.

All the previous examples (e.g., Examples 1-6) demonstrate incorporation of undispersed colloidal MCC into fluid ice cream mix prior to freezing the mix in scrape surface type freezing equipment. This example demonstrates the feasibility of introducing the colloidal MCC powder into the semi-frozen mixture upon exiting the scrape surface freezing equipment and further working/mixing/churning the semi-frozen mixture to generate enough shear stress to completely activate the colloidal MCC. The activation of colloidal MCC in this manner is sufficient to form the gel network capable of making a 5% low fat ice cream have similar eating qualities of a 10% ice cream.

A standard 5% low fat ice cream mix stabilized with a conventional guar based stabilization system was processed and frozen on the WCB Model 100 continuous freezer using a procedure similar to that of Example 1 (using scrape surface type freezing equipment). The draw temperature was recorded at 22° F. Semi-frozen mix (4376 grams) was added to a 5-gallon Hobart bowl and the bowl placed in a −30° F. blast freezer. After the semi-frozen mix had been quiescently frozen for 10 minutes, the mix was removed and it was mixed with a paddle blade under #1 setting while 26.4 grams (0.6%) of colloidal MCC was added. The mixer speed was increased to the #2 setting and mixing continued for 5 minutes. The finished temperature of the semi-frozen mix in the Hobart bowl after mixing was 21° F.

Microscopic evaluation of the semi-frozen mix showed that the colloidal MCC was not properly dispersed and not sufficiently activated yet as shown by the presence of large particles of MCC. The temperature of the semi-frozen mix was subsequently reduced to 15° F. and mixing continued for an additional 5 minutes under a #2 mixer setting. Microscopic analyses showed that these mixing conditions completely activated the colloidal MCC particulates and formed the necessary gel matrix to make a 5% fat ice cream have the eating qualities of a 10% fat ice cream. Other procedures for addition of the colloidal MCC at the step of addition may fully activate it without further freezing and mixing.

### Example 8

Two 5% fat light ice cream products were prepared using the process described in Example 2, in which 0.6% colloidal MCC was added to the base mix after pasteurization but prior to freezing. The formulas were prepared with two different solid levels; 36% (Sample #8-1) and 39.4% (Sample #8-3). The third formulation was a 10% fat ice cream stabilized with a conventional stabilizer blend (Sample #8-2) and no colloidal MCC. The formulations are given in Table 10.

Heat shock abuse was applied to one pint of each sample by placing the containers in a temperature controlled cycling cabinet programmed to maintain 20° F. for 12 hours followed by cooling to 0° F. for 12 hours. This cycling pattern was repeated for 7 days. These samples were labeled as Set B. Another set of each sample was not cycled and remained stored at −30° F. This set was labeled Set A.

TABLE 10

| | Sample # | | |
|---|---|---|---|
| | 8-1 | 8-2 | 8-3 |
| Component | % | % | % |
| Butterfat | 5 | 10 | 5 |
| MSNF | 10 | 10 | 10 |
| Whey powder | 2 | 2 | 2 |
| Sucrose | 12 | 12 | 12 |
| Corn Syrup Solids (36 DE) | 6 | 6 | 8 |
| Colloidal Microcrystalline cellulose^{a} | 0.6 | 0 | 0.6 |
| Maltodextrin M-100 | 0 | 0 | 1.2 |
| GELSTAR ® XP 3542 | 0.65 | 0 | 0.6 |
| Guar Gum (FG-60/70) | 0 | 0.04 | 0 |
| AQUALON ® 7HF | 0 | 0.07 | 0 |
| ICE 2 | 0 | 0.12 | 0 |
| Maltodextrin M-100 | 0 | 0.02 | 0 |
| Carrageenan | 0 | 0.002 | 0 |
| Total Solids | 36.25 | 40.25 | 39.4 |

^{a}Colloidal MCC Added after pasteurization

### Product Evaluation

Textural differences between the products were determined by a panel of five staff members trained and experienced in detailed texture analysis. The panelists were not provided any information on the compositions, fat content, etc. prior to or after evaluation. 3.25 oz. soufflé cups were provided for each sample, one cup/sample for each evaluator. Each sample was removed from the 0° F. freezer immediately prior to evaluation. A technician scooped approximately 2 oz. of ice cream into the serving cup using an ice cream scoop. Samples were immediately brought to the panel in the evaluation room.

Samples were evaluated at 5° F.±5° F. Each panelist received the sample immediately after it was scooped from the container. Texture attributes for each sample were evaluated in the order that they appear on the ballot. The sample was expectorated following evaluation. Panelists could re-evaluate samples as needed.

Sample evaluation results were recorded using consensus balloting. The strength of each attribute was rated on a 0-15 point intensity scale with 0=none and 15=very strong. The scale allows the use of tenths of a point, providing 150 points of differentiation. The results are given in Table 11. An explanation of the terms used to describe ice cream texture is given in Table 12.

TABLE 11
Texture Descriptive Analysis Results for Ice Cream Samples

| | Un- | | Un- | | | |
|---|---|---|---|---|---|---|
| | cycled | Un- | cycled | Cycled | | Cycled |
| | 5% | cycled | 5% | 5% | Cycled | 5% |
| | (36% | 10% | (39% | (36% | 10% | (39% |
| | Solids) | Control | Solids) | Solids) | Control | Solids) |
| | Sample # | | | | | |
| TEXTURE | A 1 | A 2 | A 3 | B 1 | B 2 | B 3 |

Surface

| | | | | | | |
|---|---|---|---|---|---|---|
| Rough | 3 | 5 | 4 | 7 | 8 | 4 |
| Crystalline | 1 | 0 | 0 | 3 | 5 | 0 |
| Oily/Fatty | 4 | 3 | 2.5 | 2 | 3 | 3 |

First Compression

| | | | | | | |
|---|---|---|---|---|---|---|
| Semi-solid | 7 | 8 | 8 | 7 | 8 | 7.5 |
| firmness | | | | | | |
| Semi-solid | 6 | 6 | 9 | 6 | 6 | 9 |
| cohesiv. | | | | | | |
| Semi-solid | 10 | 10 | 12 | 10 | 10 | 11 |
| dense. | | | | | | |
| Crystalline | 0 | 0 | 0 | 2.5 | 5 | 1 |
| Slippery | 10 | 7.5 | 10 | 6 | 7.5 | 10 |

Manipulation

| | | | | | | |
|---|---|---|---|---|---|---|
| Gritty | 2 | 1 | 0 | 4 | 5 | 1.5 |
| between | | | | | | |
| teeth | | | | | | |
| Mixes with | 7.5 | 13 | 7 | 8.5 | 12 | 8 |
| saliva | | | | | | |
| Airy/foamy | 1 | 1 | 0 | 0 | 0 | 0 |
| Thickness of | 4 | 2.5 | 5 | 3.5 | 2 | 3 |
| liquid | | | | | | |
| Manipulations | 8 | 6 | 10 | 8.5 | 7 | 10 |
| to melt | | | | | | |
| Evenness of | 10 | 14 | 14 | 10.5 | 14 | 13 |
| melt | (lumpy) | | | (lumpy) | | |
| Coldness | 11 | 13 | 13.5 | 10 | 12 | 13.5 |

Residual

| | | | | | | |
|---|---|---|---|---|---|---|
| Fatty/oily/ | 3 | 1.5 | 4 | 3 | 2 | 4 |
| film | | | | | | |
| Dairy film | 1 | 1 | 0 | 0 | 1 | 0 |
| Stabilizer ff | 2.5 | 3 | 4.5 | 2 | 2.5 | 5 |
| Chalky film | 1 | 0 | 0 | 0 | 0 | 0 |

Within the sample sets, the A samples, the uncycled samples, tended to have fewer and less discrete ice crystals than the B samples, the cycled samples, as seen in the attributes surface roughness, surface crystalline, first compression crystalline, and gritty between teeth. Sample #8-3 (5% fat; 39% Solids) was more cohesive and dense, took longer to melt during manipulation, and had more stabilizer feeling factor. Sample set B3 was least affected by heat shock. In general, both 5% fat formulations of the present invention (8-1 and 8-3) received more favorable marks than the 10% fat control (8-2).

TABLE 12
Definitions of Terms Used to Describe Ice Cream Texture
Surface

| | |
|---|---|
| Rough | The overall presence of particles (gritty, grainy, |
| | or lumpy) in the surface; lack of smoothness. |
| | [smooth--->rough] |
| Crystalline | The amount of crystals in the surface evaluated by |
| | touching the sample to the lips. |
| Oily/Fatty | The amount of oily or fatty film present on the |
| | surface evaluated by touching the sample to the |
| | lips. |

First Compression

| | |
|---|---|
| Semi-Solid | The force required to compress the matrix between |
| Firmness | the tongue and palate. |
| Semi-Solid | The amount of deformation (stringing) rather than |
| Cohesiveness | shear/cut or rupture while compressing the sample. |
| Semi-Solid | The compactness of the cross-section while |
| Denseness | compressing the sample. |
| Crystalline | The amount of crystals in the sample evaluated |
| | while compressing the sample. |
| Slippery | The amount in which the sample slides across the |
| | tongue, or to slide tongue over product (drag to |
| | slip). |

Manipulation

| | |
|---|---|
| Gritty Between | The amount of small sand like particles in the mass. |
| Teeth | |
| Mixes with Saliva | The degree to which the mass mixes with the |
| | saliva. |
| Airy/Foamy | The degree to which the liquid is airy or foamy after |
| | meltdown. |
| Thickness of | The viscosity of the sample in the mouth. |
| Liquid | |
| Manipulations to | The number of manipulations in the mouth it takes |
| Melt | to melt the sample completely. |
| Evenness of Melt | The uniformity of the mass during melting. |
| Coldness | The relative perception of coldness in the mouth |
| | during manipulation. |

Residual

| | |
|---|---|
| Fatty/Oily Film | The amount of fatty/oily film left on the mouth |
| | surfaces. |
| Dairy Film | The amount of dairy protein film left on the mouth |
| | surfaces. |
| Chalky Film | The amount of chalky film left on the mouth |
| | surfaces. |
| Stabilizer | The feeling of a coating covering the entire oral |
| Feeling Factor | cavity when mouth is open and with slight |
| | breathing; no feeling of coating when tongue |
| | touches the other surfaces of the oral cavity. |

Having described the invention, we now claim the following and their equivalents.

1. A method of producing a frozen dessert, the method comprising the steps of:
a) preparing a mix comprising ingredients suitable for the preparation of the frozen dessert, in which the mix comprises less than the desired amount of colloidal microcrystalline cellulose;
b) pasteurizing and homogenizing the mix;
c) adding to the mix an added amount of colloidal microcrystalline cellulose, the added amount being the amount necessary to achieve the desired amount of colloidal microcrystalline cellulose;
d) aerating and freezing the mix; and
e) hardening the mix;
in which the steps are carried out in the order step a), step b), step c), step d); and step e); or carried out in the order step a) step b), step d), step c), and step e), in which step c) is carried out with shear.

2. The method of claim 1 in which the added amount of colloidal microcrystalline cellulose is equal to the desired amount of colloidal microcrystalline cellulose.

3. The method of claim 1 in which the ingredients comprise sugar and milk solids non-fat.

4. The method of claim 3 in which the ingredients comprise butterfat.

5. The method of claim 4 in which:
before pasteurization and homogenization the mix comprises about 0.1 wt % to about 0.8 wt % of a stabilizer;
the added amount of colloidal microcrystalline cellulose about 0.2 wt % to about 0.9 wt %;
and the desired amount of colloidal microcrystalline cellulose is greater than about 0.3 wt % to about 1.6 wt %.

6. The method of claim 5 in which the desired amount of colloidal microcrystalline cellulose is about 1.0 wt % to about 1.4 wt %.

7. The method of claim 6 in which the in process viscosity in step b) does not exceed 400 cp.

8. The method of claim 1 in which the ingredients comprise about 15 wt % or less of butterfat.

9. The method of claim 1 in which the ingredients comprise about 5 wt % of butterfat.

10. The method of claim 1 in which the in process viscosity in step b) does not exceed 400 cp.

11. The method of any of claims 1 to 10 in which the steps are carried out in the order step a), step b), step c), step d), and step e)

12. The method of any of claims 1 to 10 in which the steps are carried out in the order step a) step b), step d), step c), and step e).

13. The method of any of claims 1 to 10 in which homogenization is carried out at a pressure of about 4.9×1010⁵ kg/m² to about 1.05×10⁶ kg/m².

14. A method of producing a frozen dessert, the method comprising the steps of:
a) preparing a first fraction, the first fraction comprising at least some ingredients suitable for the preparation of the frozen dessert, in which the first fraction contains less than the desired amount of colloidal microcrystalline cellulose;
b) preparing a second fraction, the second fraction comprising colloidal microcrystalline cellulose;
c) pasteurizing and homogenizing the first fraction;
d) pasteurizing but not homogenizing the second fraction;
e) mixing the first fraction and the second fraction in proportions appropriate to give a mix comprising the ingredients, in the desired amounts, suitable for the preparation of the frozen dessert;
f) aerating and freezing the mix; and
g) freezing the mix.

15. The method of claim 14 in which the first fraction does not comprise colloidal microcrystalline cellulose.

16. The method of claim 14 in which the first fraction comprises sugar and milk solids non-fat.

17. The method of claim 16 in which the first fraction comprises butterfat.

18. The method of claim 17 in which:
before pasteurization and homogenization the first fraction comprises about 0.1 wt % to about 0.8 wt % of a stabilizer; and
the mix comprises about 0.3 wt % to about 1.6 wt % of colloid microcrystalline cellulose.

19. The method of claim 18 in which the mix comprises about 1.0 wt % to about 1.4 wt % of microcrystalline cellulose.

20. The method of claim 19 in which the in process viscosity in step c) does not exceed 400 cp.

21. The method of claim 14 in which the ingredients comprise about 15 wt % or less of butterfat.

22. The method of claim 14 in which the ingredients comprise about 5 wt % of butterfat.

23. The method of claim 14 in which the in process viscosity in step c) does not exceed 400 cp.

24. A method of producing a frozen dessert, the method comprising the steps of:
a) preparing a mix comprising ingredients suitable for the frozen dessert, in which the mix comprises the desired amount of colloidal microcrystalline cellulose and in which the colloidal microcrystalline cellulose is fluid bed dried microcrystalline cellulose;
b) pasteurizing and homogenizing the mix, in which the homogenization is carried out at a pressure of about 4.9×1010⁵ kg/m² to about 1.05×10⁶ kg/m², and in which the in process viscosity in step b) does not exceed 400 cp;
c) aerating and freezing the mix; and
d) hardening the mix.

25. The method of claim 24 in which the mix comprises sugar and milk solids non-fat.

26. The method of claim 25 in which the ingredients comprise butterfat.

27. The method of claim 24 in which the desired amount of colloidal microcrystalline cellulose is about 1.0 wt % to about 1.4 wt %.

28. The method of claim 27 in which the in process viscosity in step c) does not exceed 400 cp.

29. The method of claim 26 in which the ingredients comprise about 15 wt % or less of butterfat.

30. The method of claim 29 in which the ingredients comprise about 5 wt % of butterfat.

31. The method of claim 24 in which the in process viscosity in step c) does not exceed 300 cp.

32. A frozen dessert produced by the method of claim 1.

33. The frozen dessert of claim 32 in which the frozen dessert comprises sugar, milk solids non-fat, about 15 wt % or less of butterfat, and about 0.3 wt % to about 1.6 wt % of the colloidal microcrystalline cellulose.

34. The frozen dessert of claim 33 in which the frozen dessert comprises about 1.0 wt % to about 1.4 wt % of the colloidal microcrystalline cellulose.

35. The frozen dessert of claim 34 in which the frozen dessert less than 40% melted after 120 minutes at about 19.4° C.

36. The frozen dessert of claim 32 in which the frozen dessert comprises about 5% butterfat and, in sensory testing, the frozen dessert is preferred by at least 90% of a sensory panel over a frozen dessert that contains about 10% butterfat and less than 0.15 wt % of hydrocolloid stabilizer.

37. A frozen dessert produced by the method of claim 14.

38. The frozen dessert of claim 37 in which the frozen dessert comprises sugar, milk solids non-fat, about 5 wt % of butterfat, and about 0.3 wt % to about 1.6 wt % of the colloidal microcrystalline cellulose.

39. The frozen dessert of claim 38 in which the frozen dessert comprises about 1.0 wt % to about 1.4 wt % of the colloidal microcrystalline cellulose.

40. The frozen dessert of claim 38 in which the frozen dessert less than 40% melted after 120 minutes at about 19.4° C.

41. A frozen dessert produced by the method of claim 24.

42. The frozen dessert of claim 41 in which the frozen dessert comprises sugar, milk solids non-fat, about 5 wt % of butterfat, and about 0.3wt % to about 1.6 wt % of the colloidal microcrystalline cellulose.

43. The frozen dessert of claim 42 in which the frozen dessert comprises about 1.0 wt % to about 1.4 wt % of the colloidal microcrystalline cellulose.

44. The frozen dessert of claim 43 in which the frozen dessert less than 40% melted after 120 minutes at about 19.4° C.

45. A method of producing a frozen dessert comprising the steps of preparing a dessert composition and freezing said dessert composition, wherein colloidal microcrystalline cellulose is added to said dessert composition during at least one of before, during or after said freezing step with the proviso that at least a portion of said colloidal microcrystalline cellulose is activated during or after said freezing step.

46. The method of claim 45, wherein at least 50% of said colloidal microcrystalline cellulose is activated during or after said freezing step.

47. The method of claim 45, wherein at least 60% of said colloidal microcrystalline cellulose is activated during or after said freezing step.

48. The method of claim 45, wherein at least 70% of said colloidal microcrystalline cellulose is activated during or after said freezing step.

49. The method of claim 45, wherein at least 80% of said colloidal microcrystalline cellulose is activated during or after said freezing step.

50. The method of claim 45, wherein at least 90% of said colloidal microcrystalline cellulose is activated during or after said freezing step.

51. The method of claim 45, wherein at least 95% of said colloidal microcrystalline cellulose is activated during or after said freezing step.

52. The method of claim 45, wherein at least 98% of said colloidal microcrystalline cellulose is activated during or after said freezing step.

53. The method of claim 45, wherein at least 99% of said colloidal microcrystalline cellulose is activated during or after said freezing step.

54. The method of claim 45, wherein at least 100% of said colloidal microcrystalline cellulose is activated during or after said freezing step.

55. The method in any one of claims 1 or 14, wherein said colloidal microcrystalline cellulose comprises carboxymethyl cellulose having a viscosity of about 25 to about 50 cp for a 2% solution as determined by a LVF Brookfield viscometer; spindle #1 and #2; speed: 30 rpm or a viscosity of about 50 to about 200 cp for a 4% solution as determined by a LVF Brookfield viscometer; spindle #1 and #2; speed: 60 rpm or mixtures thereof.

56. The method in any one of claims 1 or 14, wherein said colloidal microcrystalline cellulose comprises spray dried microcrystalline cellulose.

57. The method in any one of claims 1 or 14, wherein said colloidal microcrystalline cellulose comprises: (i) carboxymethyl cellulose having (a) a viscosity of about 25 to about 50 cp for a 2% solution as determined by a LVF Brookfield viscometer; spindle #1 and #2; speed: 30 rpm or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose.

58. The method in any one of claims 1 or 14, wherein said colloidal microcrystalline cellulose consists of: (i) carboxymethyl cellulose having (a) a viscosity of about 25 to about 50 cp for a 2% solution as determined by a LVF Brookfield viscometer; spindle #1 and #2; speed: 30 rpm or (b) a viscosity of about 50 to about 200 cp for a 4% solution as determined by a LVF Brookfield viscometer; spindle #1 and #2; speed: 60 rpm; or mixtures of (a) or (b); and (ii) microcrystalline cellulose; wherein said colloidal microcrystalline cellulose has a viscosity greater than 150 cp when measured at 2.6% solids using RVT Brookfield viscometer, spindle #1 at 20 rpm.

59. A frozen dessert composition comprising colloidal microcrystalline cellulose wherein said colloidal microcrystalline cellulose consists of: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein said colloidal microcrystalline cellulose has a viscosity greater than 150 cp when measured at 2.6% solids using RVT Brookfield viscometer, spindle #1 at 20 rpm.

60. The frozen dessert composition of claim 59, wherein said frozen dessert composition further comprises 3-8% by weight of butterfat.

61. A colloidal microcrystalline cellulose consisting of: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein said colloidal microcrystalline cellulose has a viscosity greater than 150 cp when measured at 2.6% solids using RVT Brookfield viscometer, spindle #1 at 20 rpm.

62. The colloidal microcrystalline cellulose of claim 60 wherein said carboxymethyl cellulose is present in an amount of 5-20 wt % by weight of the colloidal microcrystalline cellulose.

63. The colloidal microcrystalline cellulose of claim 60 wherein said carboxymethyl cellulose is present in an amount of 15 wt % by weight of the colloidal microcrystalline cellulose.

64. A colloidal microcrystalline cellulose consisting of coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein said colloidal microcrystalline cellulose has a viscosity greater than 150 cp when measured at 2.6% solids using RVT Brookfield viscometer, spindle #1 at 20 rpm, and said carboxymethyl cellulose and microcrystalline cellulose are spray dried after being coprocessed.

65. The colloidal microcrystalline cellulose of claim 64 wherein said carboxymethyl cellulose is present in an amount of 5-20 wt % by weight of the colloidal microcrystalline cellulose.

66. The colloidal microcrystalline cellulose of claim 64 wherein said carboxymethyl cellulose is present in an amount of 15 wt % by weight of the colloidal microcrystalline cellulose.

67. A frozen dessert composition comprising the colloidal microcrystalline cellulose of any of claims 64-67.

68. A frozen dessert composition comprising colloidal microcrystalline cellulose wherein said colloidal microcrystalline cellulose consists of the colloidal microcrystalline cellulose of any of claims 64-67.

69. The method in any one of claims 1 or 14, wherein said colloidal microcrystalline cellulose comprises coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein said colloidal microcrystalline cellulose has a viscosity greater than 150 cp when measured at 2.6% solids using RVT Brookfield viscometer, spindle #1 at 20 rpm, and said carboxymethyl cellulose and microcrystalline cellulose are spray dried after being coprocessed.

70. The method in any one of claims 1 or 14, wherein said colloidal microcrystalline cellulose consists of coprocessed: (i) carboxymethyl cellulose having (a) a viscosity of about 25 to about 50 cp for a 2% solution as determined by a LVF Brookfield viscometer; spindle #1 and #2; speed: 30 rpm; or (b) a viscosity of about 50 to about 200 cp for a 4% solution as determined by a LVF Brookfield viscometer; spindle #1 and #2; speed: 60 rpm; or mixtures of (a) and (b); and (ii) microcrystalline cellulose; wherein said colloidal microcrystalline cellulose has a viscosity greater than 150 cp when measured at 2.6% solids using RVT Brookfield viscometer, spindle #1 at 20 rpm, and said carboxymethyl cellulose and microcrystalline cellulose are spray dried after being coprocessed.

71. The method of claim 45, wherein at least 1% of said colloidal microcrystalline cellulose is activated during or after said freezing step.

72. The method of claim 45, wherein at least 5% of said colloidal microcrystalline cellulose is activated during or after said freezing step.

73. The method of claim 45, wherein at least 10% of said colloidal microcrystalline cellulose is activated during or after said freezing step.

74. The method of claim 45, wherein at least 35% of said colloidal microcrystalline cellulose is activated during or after said freezing step.
